(19) United States
(12) Patent Application Publication
(10) Pub. No.: US 2007/0278346 A1
(43) Pub. Date: Dec. 6, 2007

(54) Aircraft cabin configuration

(75) Inventors: Elisabeth Masset-Bosc, Blagnac (FR); Clement Beaunis, Blagnac (FR); Michael Carr, Blagnac (FR)

Correspondence Address: NIXON & VANDERHYE, PC, 901 NORTH GLEBE ROAD, 11TH FLOOR, ARLINGTON, VA, 22203, US

(73) Assignee: Airbus SAS, Blagnac (FR)

(21) Appl. No.: 11/798,826

(22) Filed: May 17, 2007

(30) Foreign Application Priority Data
May 18, 2006 (GB) 0609888.3

(51) Int. Cl. B64D 11/00

(52) U.S. Cl. 244/118.5

(57) ABSTRACT

In one embodiment, an aircraft comprises a fuselage 1, a passenger cabin 3 housed therein, and a primary opening 13 for accessing the cabin 3. The opening 13 is located in a central region extending from 20% to 80% of the total cabin length. The opening 13 has a width greater than 1 m, so as to be suitable for the side-by-side, simultaneous passage of at least two adult persons walking therethrough. In another embodiment, an aircraft comprises a passenger cabin 3, having a first set of seats 7a, and a second set of seats 7b separated from the first 7a set of seats by a passageway 15 transverse to the length of the cabin 5. The first and second sets of seats 7a, 7b each face towards the passageway 15. These embodiments may enable a reduction in turnaround time.

### RELATED APPLICATIONS

The present application is based on, and claims priority from, UK Patent Application Number 0609888.3, filed May 18, 2006, the disclosure of which is hereby incorporated by reference herein in its entirety.

### BACKGROUND OF THE INVENTION

The present invention relates to aircraft, and more particularly to an aircraft cabin configuration.

It is often desirable to move passengers on and off an aircraft as quickly as possible, thereby decreasing turn-around time. Aircraft are typically provided with access doors at the front and/or rear of the aircraft. Such an arrangement can, however, lead to congestion problems when passengers are embarking, or disembarking the aircraft.

On many aircraft it is also desirable to carry as many passengers as possible. The capacity of aircraft is typically limited by the number of seats that it is possible to install in the cabin. The number of seats, in turn, tends to be determined by the length of the cabin and the leg room allocated to the passengers. It is desirable to efficiently use the cabin space available.

### SUMMARY OF THE INVENTION

The present invention seeks to mitigate or remove congestion on an aircraft during embarking and disembarking, to reduce turn-around time, and/or to provide an efficient cabin boarding arrangement. Alternatively or additionally, the present invention seeks to increase the capacity of, and/or more efficiently use the capacity of, an aircraft cabin.

The present invention provides an aircraft comprising a fuselage, a passenger cabin housed therein, and a primary opening for accessing the cabin, wherein the opening is defined by, and is located in a side of, the fuselage, the opening is located in a region of the cabin extending from 20% to 80% of the total cabin length, and the opening has a width greater than 1 m, so as to be suitable for the side-by-side, simultaneous passage of at least two adult persons walking therethrough.

Certain embodiments of the present invention therefore enable at least two passengers to enter the aircraft side-by-side simultaneously through the same opening. It may therefore be possible to increase the embarking/disembarking rate of passengers onto/off the aircraft, thereby decreasing turnaround times. In addition, the arrangement of the cabin and the opening may be such that the flow of passengers through the opening may, once inside the cabin, be separated into two discrete streams moving in opposite directions along the length of the aircraft cabin. Such an arrangement may reduce turn-around times, since it may reduce passenger congestion caused by passengers moving past each other in different directions. Certain embodiments of the present invention may also enable the early occupancy of seats in or near the central region of the aircraft.

Aircraft exit arrangements tend to be governed by the maximum distance a seat can be located from an exit and/or the maximum number of passengers within the vicinity of an exit of a particular size. The primary opening (i.e. an opening providing access to the cabin) on an aircraft according to certain embodiments of the present invention may be relatively large, and may be permitted to have a correspondingly large number of passengers for whom the opening is the nearest available exit. Therefore, an aircraft according to certain embodiments of the present invention may not need many, if any, additional exits. It will be appreciated that in some embodiments additional exits in the form of emergency exits may need to be provided. An aircraft according to such embodiments of the present invention may not necessarily need many, if any, additional regular exits. The term “regular exit” may cover within its scope an exit that may be used as an emergency exit, but excludes an exit that would only ever be used as an emergency exit. Certain embodiments of the present invention may therefore enable a more efficient use of the cabin length by removing the need for certain exits, particularly regular exits, such as those regular exits located at the fore/rear of the cabin (in which the primary opening may be located). It shall be appreciated that the term ‘exit’ is used herein to refer to an opening through which passengers may embark, as well as disembark, the aircraft. Such an opening will typically be associated with a door. It will be appreciated that in some embodiments additional exits in the form of emergency exits may need to be provided.

It will be understood that the extent of the region (in which the primary opening is located) with reference to the total cabin length, is based on the front of the cabin being at 0% of the length of the cabin, and the rear of the cabin being at 100% of the length of the cabin. Thus the above-mentioned region (in which the primary opening is located) is of a length equal to 60% of the length of the cabin, and is centered midway along the cabin. It will also be understood that the position of an exit is defined by the position of its centre.

The primary opening is preferably the main opening used on the aircraft for passenger embarkation/disembarkation, but need not necessarily be. For example, the aircraft may comprise an additional large opening outside the region extending from 20% to 80% of the total cabin length.

The primary opening may be generally rectangular. It will of course be appreciated that the opening, and in particular a substantially rectangular opening, need not however contain any right-angled corners. For example the corners of the opening may have radii of up to ⅙ of the width of the opening.

The width of the primary opening may be greater than 1.05 m. The width of the primary opening may be greater than 1.1 m. The width of the primary opening may be greater than 1.3 m. The width of the primary opening may be greater than 1.5 m. The width of the primary opening may be less than 2.5 m, and is more preferably less than 2.0 m.

The height of the primary opening may be greater than 1.5 m, and is preferably greater than 2.0 m. The height of the primary opening may be less than 3.0 m and is preferably less than 2.5 m.

As is understood by the skilled person, many aircraft exits are defined by, and adhere to, Federal Aviation Authority (FAA) Federal Aviation Regulations (FAR). The primary opening may be a Type-A exit as defined Section 25.807 of the Federal Aviation Authority (FAA) Federal Aviation Regulations (FAR).

The aircraft may comprise a door associated with the opening. The door is preferably arranged to seal the opening. The door may be arranged as a double-door, but is preferably a single door (a single door tending to be more suitable for use on an aircraft due to, inter alia, pressurization considerations).

The primary opening may be located in a region between 30% and 70% of the length of the cabin. The primary opening may be located in a region between 40% and 60% of the total length of the cabin.

The aircraft cabin may comprise a plurality of passenger seats. The number of passenger seats located to one side of the primary opening (in a longitudinal direction) may be between 50% and 150% of the number of passenger seats located to the other side of the primary opening. The number of passenger seats located to one side of the primary opening (in a longitudinal direction) may be between 75% and 125% of the number of passenger seats located to the other side of the primary opening. The number of passenger seats located either side of the primary opening (in a longitudinal direction) may be substantially equal.

The primary opening may be located within a central region but off-centre along the length of the cabin. Such an arrangement is particularly beneficial on an aircraft having a low-wing configuration because, in such a configuration, access to the opening may not be restricted due to the presence of the wing and/or engine structure. Thus, the opening may be located in a region between 20% and 50% of the total length of the cabin. The opening may be located in a region between 20% and 30% of the total length of the cabin. The opening may be located in a region between 50% and 80% of the total length of the cabin. The opening may be located in a region between 70% and 80% of the total length of the cabin.

In the context of an aircraft according to certain embodiments of the present invention, access to the primary opening by way of conventional airstairs may, in some circumstances, not be possible due, for example, to the presence of surrounding aircraft structure. A walkway provided as part of an aircraft having such an opening is however disclosed in GB Patent Application GB0609892.5 having a filing date of 18 May 2006, entitled “Aircraft Walkway”, Airbus UK Limited ref: XA2220. The contents of that application are fully incorporated herein by reference. The aircraft of the present invention may incorporate any of the features disclosed in that U.S. patent application. In particular, the claims of the present application may be amended to include the feature of the aircraft including the walkway which is associated with the primary opening and the walkway may further be defined with reference to features of the walkway described or claimed in the above-mentioned related patent application. Such a walkway may also assist in reducing turnaround times.

The passenger cabin may comprise a passageway extending in a direction transverse to the length of the cabin and being arranged to adjoin the opening. The passageway is preferably of similar, and more preferably substantially equal, width to the primary opening. For example, the passageway may be greater than 1 m wide. The passageway may be substantially perpendicular to the length of the fuselage. The passageway may extend from the opening to as far as a longitudinal gangway, along the length of the cabin, furthest from the opening. The passageway may extend across substantially the entire width of the cabin.

Certain embodiments of the present invention may be of particular benefit to small or medium-sized aircraft. Aircraft of this size tend to be used for short-range flights, in which turn-around time is particularly important. Aircraft exit sizes tend to scale, to some degree, with the aircraft size and/or passenger capacity. Thus it may be known in the art (for example see U.S. Pat. No. 6,766,986) for large aircraft to comprise exits having a width of 1 m or greater, but smaller aircraft tend to only have smaller exits. It is not thought to be known to use large exits on relatively small, generally short-range, aircraft. In accordance with embodiments of the present invention however, there are benefits in providing such large doors on small aircraft in contrast to the conventional arrangements of the prior art. The aircraft of certain embodiments of the present invention may be of a size equivalent to an aircraft designed to carry no more than 300 passengers, and more preferably no more than 250 passengers, and yet more preferably no more than 220 passengers. The aircraft may be of a size equivalent to an aircraft designed to carry no more than 150 passengers. The aircraft may be of a size equivalent to an aircraft designed to carry more than 10 passengers, and more preferably more than 30 passengers. The aircraft may be lighter than 200 tonnes dry weight, and more preferably lighter than 100 tonnes dry weight. The aircraft may have a fuselage having an external width of less than 6 m, possibly less than 5 m and potentially even as small as less than 4 m.

The aircraft may comprise a longitudinal passenger aisle. The aircraft may comprise a plurality of passenger seats located either side of the passenger aisle. The aircraft may comprise only one longitudinal passenger aisle (i.e. along any given region along the length of the aircraft). The passenger aisle may be aligned with the longitudinal axis of the aircraft.

The aircraft may have a low wing configuration. The aircraft may have a high wing configuration. The aircraft may have a central wing configuration.

The aircraft may comprise a main wing, the junction of the wing and the fuselage defining a wing root, the wing root being located approximately centrally along the aircraft fuselage. The wing root may, in some embodiments of the invention, be located towards the rear of the fuselage.

The aircraft may comprise a further opening arranged in accordance with the primary opening according to any aspect of the present invention. The further opening may be located directly opposite the primary opening. The arrangement of the openings may be symmetrical about the longitudinal centre-line of the aircraft fuselage. The aircraft may comprise at least one pair of openings, each opening being arranged in accordance with the primary opening according any aspect of the present invention.

Alternatively, or additionally, the aircraft may comprise two primary openings, which are located on the same side of the fuselage. Such an arrangement may be particularly advantageous in the embodiment of the present invention in which a primary opening is located off-centre of the cabin centre (for example between 20% and 30% of the total length of the cabin or between 70% and 80% of the total length of the cabin). An aircraft having two such openings is thought to be a particularly efficient arrangement in facilitating boarding of passengers.

The aircraft may further comprise a secondary opening for accessing the cabin, and a secondary door associated with the secondary opening, wherein the secondary opening is defined by, and located in a side of, the fuselage, the secondary opening is located at an end region of the cabin, and the secondary opening has a width less than 1 m, so as to be unsuitable for the side-by-side, simultaneous passage of at least two adult persons walking therethrough. The secondary opening may be a type-B opening. The secondary opening may be a type-C opening. The secondary opening may be smaller than a type-C exit. The secondary opening may be a regular exit. The secondary opening may be located in the rear of the fuselage. The secondary opening may be located in the fore of the fuselage. The aircraft may comprise a plurality of secondary openings. The aircraft may comprise at least one pair of secondary openings.

The present invention also provides, according to a further aspect of the invention, a method of facilitating boarding of passengers onto an aircraft, the aircraft comprising a passenger cabin and an opening having a width of greater than 1 m for accessing the passenger cabin, the method comprising the steps of directing a first passenger and a second passenger to pass simultaneously and side-by-side, through the opening. The opening may be defined by, and located in a side of, the fuselage of the aircraft. The opening may be located in region extending from 20% to 80% of the total cabin length.

The present invention also provides, according to a further aspect of the invention, a method of facilitating boarding of passengers onto an aircraft, the aircraft including an opening located in a region extending from 20% to 80% of the total cabin length, the method comprising the step of directing a first passenger and a second passenger to pass simultaneously and side-by-side, through the opening.

According to yet another aspect of the invention, there is provided a method of facilitating boarding of passengers onto the aircraft according to any aspect of the present invention, the method comprising the steps of: (a) providing the primary opening; and (b) directing a first passenger and a second passenger to board simultaneously and side-by-side through the primary opening. Such a method may facilitate an increase in embarkation and disembarkation speed, thereby facilitating a reduction in turn-around times. This increase in embarkation and disembarkation speed may be as a result of an increased flow of passengers through the opening (in comparison with an opening of width less than 1 m, so as to be unsuitable for simultaneous passage of at least two persons therethrough); an increased accessibility of seats in or near the centre region of the aircraft (in comparison with an opening in the front and/or rear of the aircraft passenger cabin); or a combination thereof.

The method may further comprise the steps of (c) directing the first passenger, once through the primary opening, in a first direction along the cabin; and (d) directing the second passenger, once through the primary opening, in a second direction along the cabin, the second direction being opposite to the first direction. The first direction is preferably such that the first passenger moves in a direction which is initially away from the second passenger. The second direction is preferably such that the second passenger moves in a direction which is initially away from the first passenger. Directing passengers in this way may reduce turn-around times, since it may reduce passenger congestion caused by passengers moving past each other in different directions. Such an arrangement may also facilitate the early occupancy of seats in or near the central region of the aircraft.

Directions may be provided implicitly by means of the layout structure of aircraft. Passengers will preferably understand, from the layout of the aircraft, the actions required during embarkation and disembarkation of the aircraft. Directions may be provided explicitly for example by signs, markers or other written instructions, or by verbal instructions by the air crew.

In a cabin arrangement of the prior art, the cabin seating layout may be such that the cabin comprises one large set of seats extending between the fore and rear of the cabin. Also in another cabin arrangement of the prior art, the cabin may comprise at least two similarly-orientated sets of seats, divided from one another by a relatively small transverse passageway (such as a passageway for use with a type-C or smaller exit). In such cabin arrangements, the orientation of the seats is such that the transverse passageway is bordered, on one side, by the back of the rearmost seats of one set of seats, and on the other side, by the front (i.e. including the leg room) of another set of seats.

According to yet another aspect of the present invention there is provided an aircraft comprising a passenger cabin, the passenger cabin comprising a first set of seats, and a second set of seats separated from the first set of seats by a passageway extending in a direction transverse to the length of the cabin, the first and second sets of seats each facing towards the passageway. The first and/or second set of seats may border the passageway. The first set of seats may face forwards and be located rearwards of the passageway. The second set of seats may face rearwards and be located forwards of the passageway. A region of the first set of seats (for example the foremost row of the first set of seats) may be arranged such that the passenger leg room of the seats in this region extends into the passageway. A region of the second set of seats (for example the rear-most row of seats of the second set of seats) may also be arranged such that the passenger leg room of the seats in this region extends into the passageway (those seats facing the opposite direction to the seats in the first set). (It shall, of course, be understood that reference herein to foremost and rearmost is with respect to the passenger cabin as a whole).

Certain embodiments of the present invention may therefore facilitate an efficient use of cabin space, and more particularly an efficient use of the cabin length.

In particular, certain embodiments of the present invention may enable the leg room (rather than the back of the seats) of at least a portion of both the first and second set of seats, to extend into the passageway. It may therefore be possible to include more seats in the cabin, in comparison with an arrangement in which the first and second sets of seats are facing in the same direction. For example, the back of the foremost seats in the second set of seats, and the back of the rearmost seats in the first set of seats may be located against an aircraft structure, for example at an extreme end of the cabin, thereby enabling a greater seating capacity, without adversely impacting on the useable width of the passageway.

It may also be possible to include the same number of seats, but have a wider useable portion of transverse passageway, in comparison with the above-mentioned known arrangements of the prior art. Alternatively or additionally, it may be possible to include the same number of seats but have more leg-room allocated to each seat in comparison with the above-mentioned known arrangements.

A region of the first set of seats (for example the rearmost row of the first set of seats) may be arranged such that the back of the seats in this region abut, or are close to abutting, the cabin rear bulkhead. A region of the second set of seats (for example the foremost row of seats of the second set of seats) may also be arranged such that the back of the seats in this region abut, or are close to abutting, the cabin fore bulkhead. The back of the seats, may of course, be arranged to abut, or be close to abutting, other parts of the aircraft structure such as a partitioning wall defining an aircraft lavatory or any other type of aircraft compartment.

The first set of seats may comprise a multiplicity of uniformly arranged seats. The second set of seats may comprise a multiplicity of uniformly arranged seats. The first and/or second set of seats may comprise a plurality of rows, for example more than three rows. Each row may comprise a plurality of seats, for example more than three seats. Certain seats in the row may be separated from one another by a passageway. The first and/or second set of seats may comprise at least 10 seats, and more preferably more than 20 seats, and yet more preferably more than 40 seats. The first and second sets of seats may be defined by two blocks of seats.

The transverse passageway may be located in a central region of the aircraft cabin. The transverse passageway may be located in a region of the cabin between 20% and 80% of the total cabin length. The passageway may be located in a region between 30% and 70% of the length of the cabin. The passageway may be located in a region between 40% and 60% of the total length of the cabin. The passageway may be located just off-centre of the cabin, but within a central region. Thus, the passageway may be located in a region between 20% and 50% of the total length of the cabin. The passageway may be located in a region between 20% and 30% of the total length of the cabin. The passageway may be located in a region between 50% and 80% of the total length of the cabin. The passageway may be located in a region between 70% and 80% of the total length of the cabin.

The passageway may be a relatively thin passageway, for example a passageway adjoining, and for use with, a relatively small exit, such as a type-C exit. The above-described cabin layout is of particular benefit, however, on an aircraft comprising a relatively wide opening, such as the primary opening as described herein. The passageway may be arranged to adjoin with the opening. The passageway is preferably of similar width to the primary opening. For example, the width of the passageway may be greater than 1 m. The width of the passageway may be greater than 1.3 m. The width of the passageway may be greater than 1.5 m. The width of the passageway may be less than 3.0 m, and is more preferably less than 2.0 m.

The aircraft may comprise a third set of seats next to, but facing the opposite direction to that of, either the first or the second set of seats. The third set of seats may be directly adjacent to either the first set or the second set of seats, so that the seats of the adjacent rows of the third set of seats and the adjacent set of seats are arranged back-to-back. The aircraft may comprise a multiplicity of sets of seats arranged in accordance with certain aspects of the present invention described herein, each set of seats being separated from another set of seats by a passageway extending in a direction transverse to the length of the cabin. A further set of seats may, of course, additionally be separated from another set of seats by a longitudinal passageway in a direction parallel to the length of the cabin.

The aircraft may comprise a plurality of passageways, each passageway adjoining a primary opening, or a secondary opening, as described herein.

It shall be appreciated that features of one aspect of the present invention are equally applicable to another aspect of the present invention. For example, the cabin may comprise a first transverse passageway adjoining an opening having a width greater than 1 m, so as to be suitable for the side-by-side, simultaneous passage of at least two adult persons walking therethrough, and a second transverse passageway adjoining a secondary opening having a width of less than 1 m, so as to be unsuitable for the side-by-side, simultaneous passage of at least two adult persons walking therethrough. In such a cabin, the second set of seats may be separated from the first set of seats by the first transverse passageway, and a third set of sets (facing in a first direction) may be separated from a fourth set of seats (facing in a second direction) by the second transverse passageway, the first direction being opposite the second direction such that both the first and second sets of seats face towards the first passageway, and both the third and fourth sets of seats face towards the second passageway.

### DESCRIPTION OF THE DRAWINGS

Various embodiments of the invention will now be described, by way of example only, with reference to the accompanying schematic drawings of which:

FIGS. 1a and 1b show typical, known aircraft passenger cabins;

FIG. 2 shows a passenger cabin on an aircraft according to a first embodiment of the present invention;

FIG. 3 shows a passenger cabin on an aircraft according to a second embodiment of the present invention;

FIG. 4 shows a passenger cabin on an aircraft according to a third embodiment of the present invention;

FIG. 5 shows a passenger cabin on an aircraft according to a fourth embodiment of the present invention; and

FIG. 6 shows a passenger cabin on an aircraft according to a fifth embodiment of the present invention.

### DETAILED DESCRIPTION

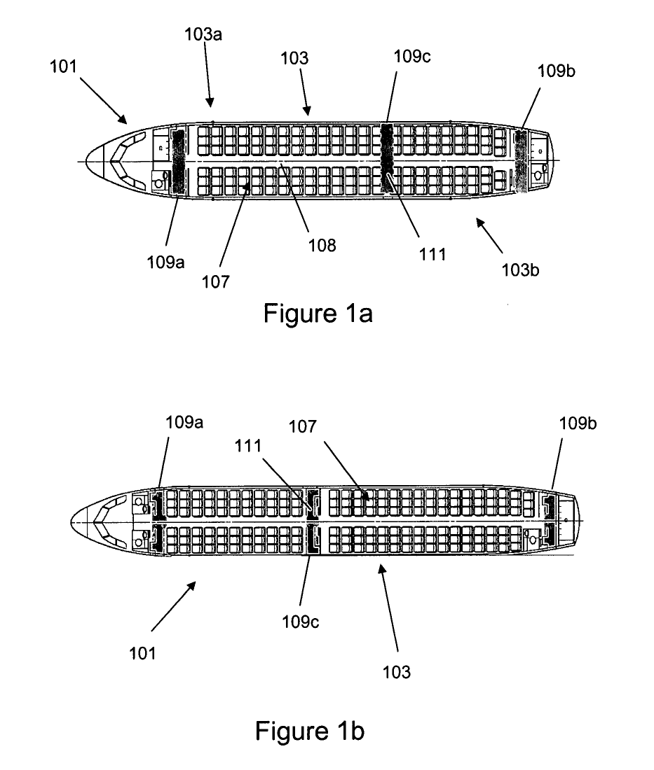

FIG. 1a shows a passenger cabin on an aircraft of the prior art (for the sake of clarity, the aircraft wings are not shown, and the fuselage 101 is shown in cut-away view). The aircraft comprises a fuselage 101 with a passenger cabin 103 housed therein. The passenger cabin 103 comprises four sets of seats 107 arranged along the length of the fuselage 101, either side of a central aisle 108. The cabin comprises a total of one hundred and thirty seven (137) passenger seats.

The cabin comprises a first pair of exits 109a at the foremost end 103a of the cabin, and a second pair of exits 109b at the rearmost end 103b of the cabin. The cabin area between each pair of exits is shaded for clarity. Each exit is a Type-C exit in accordance with FFA Regulations (namely each exit is a floor-level exit with a rectangular opening of not less than 30 inches (0.762 m) wide by 48 inches (1.22 m) high, with corner radii not greater than 10 inches (0.254 m)), but is not as large as a type-B exit. It shall be appreciated that the term ‘exit’ is used herein to refer to an opening through which passengers may embark, as well as disembark, the aircraft.

Aircraft regulations govern that the maximum number of passengers within the vicinity of a type-C exit is 55. Since the cabin 103 is arranged to carry 137 passengers, the cabin includes a third exit 109c. The third exit 109c is a Type-III exit (namely a rectangular opening of not less than 20 inches (0.51 m) wide by 36 inches (0.92 m) high with corner radii not greater than 7 inches (0.18 m), and with a step-up inside the airplane of not more than 20 inches (0.51 m)). The third exit 109c adjoins a thin passageway 111 extending in a direction transverse to the length of the fuselage 101, which divides the sets of seats. However, the third exit 109c is designed for emergency use only.

FIG. 1b shows a second typical known aircraft passenger cabin. The aircraft is slightly larger than that shown in FIG. 1a. The passenger cabin 103 comprises 165 seats arranged in four sets of seats 107 along the length of the fuselage 101.

The aircraft comprises a first and second pair of exits 109a, 109b at either end of the cabin 103. In addition the aircraft comprises a third pair of exits 109c located at approximately 40% the of the cabin length. In contrast to the aircraft shown in FIG. 1a, the third pair of exits 109c is arranged to be used during conventional embarkation and disembarkation. All the exits are type-C exits measuring 0.81 m width and 1.86 m height.

The cabin arrangement described with reference to FIGS. 1a and 1b has a number of disadvantages. Firstly, Type-C exits are unsuitable for the simultaneous side-by-side passage of more than one person. Thus, the rate of passengers boarding into the cabin is limited to one person at a time through each exit 109a, 109b (and 109c in the aircraft of FIG. 1b). This may limit the rate of passengers embarking and/or disembarking the aircraft and thus limit turn-around times.

In addition, the third exit 109c and associated transverse passageway 111 occupy space in the cabin that could otherwise be used for seating.

The cabin arrangement of FIG. 1a also makes it difficult for passengers to quickly reach the seats near the centre of the aircraft cabin. Furthermore, in both aircraft cabin arrangements, passengers often obstruct movement of other passengers through the central aisle by stowing their baggage prior to sitting in their seats. Thus, congestion may be caused if passengers seek to occupy seats close to the exit, instead of moving towards the centre of the aircraft cabin.

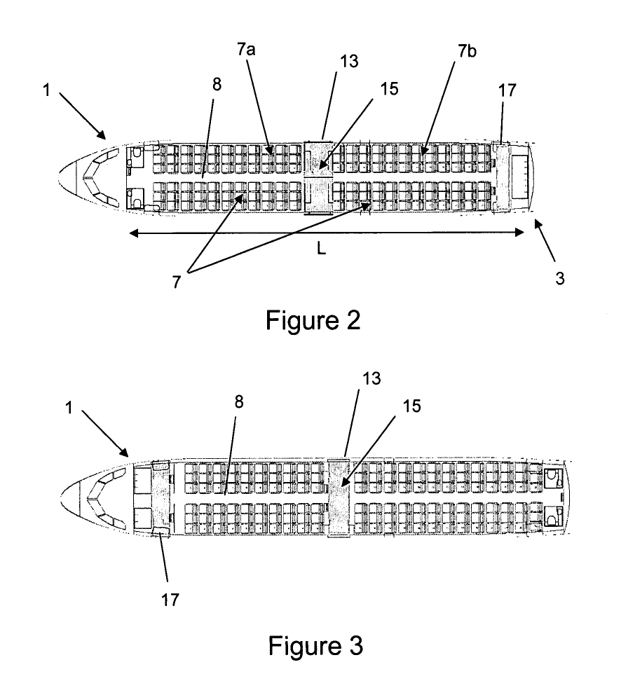

FIG. 2 shows an aircraft fuselage according to a first embodiment of the present invention. The aircraft is a relatively small passenger aircraft, primarily used on short-haul flights. The aircraft comprises a fuselage 1 and a passenger cabin 3 housed therein. The cabin comprises four sets of seats 7 arranged along its length L, either side of a central aisle 8.

The cabin includes a pair of primary exits 13 defined by, and located in either side of the fuselage 1. The centre of each exit 13 is located at approximately 45% of the total cabin length L (measuring from the front of the cabin). The pair of primary exits 13 is symmetrical about the centre-line of the fuselage 1, and thus reference herein to the primary exit can be taken to refer to both primary exits.

The primary exit 13 is a type-A, generally-rectangular exit having a width of 1.10 m, and a height of 2.1 m. The exit thus comprises an opening of sufficient width to allow side-by-side simultaneous passage of two adult persons walking therethrough. The primary exit 13 adjoins a correspondingly large passageway 15 extending across the width of the fuselage 1 in a direction normal to the length of the fuselage 1.

Large exits, such as those of Type-A size and greater, tend to only be used on large, generally long-range, aircraft. It is not thought to be known to use such large exits on relatively small, generally short-range, aircraft such as the aircraft of the present embodiments.

The primary exit 13 comprises a single door associated with the opening. The door is of similar size to the opening, and of complementary shape, and is thus arranged to seal the opening. The door is shown in the closed position in FIG. 2.

The cabin also includes a secondary pair of exits 17. The secondary pair of exits is substantially identical to the rear pair of exits 109b described with reference to FIG. 1a.

The combination of the large primary exit 13 (through which passengers may enter side-by-side simultaneously) and the Type-C secondary exit 17 enables, purely by way of the size of the openings, a greater rate of passenger embarking and/or disembarking in comparison to an aircraft with only two type-C exits.

The provision of the primary exit 13 in the central region of the cabin 3 also facilitates a reduction in passenger congestion. In particular, the flow of passengers (not shown) through the primary exit 13 is arranged to divide into two discrete streams of people that travel in opposite directions along the central aisle 8. During use, passengers entering the left-hand side (as shown in FIG. 2) of the opening 13 are directed (by signs in the cabin interior) to the two fore sets of seats 7a (i.e. in a direction which is initially away from the passengers on the right-hand side of the opening 13), whilst passengers entering the right-hand side of the opening 13 are directed (also by signs in the cabin interior) to the two rear sets of seats 7b (i.e. in a direction which is initially away from the passengers on the left-hand side of the opening 13).

This reduces the number of passengers travelling in opposite directions along the aisle 8 thereby decreasing the time for passengers to reach, and sit down in, their seat. The location of the pair of primary exits also allows passengers to reach seats near the centre, and fore of the aircraft, whilst the secondary exits allow passengers to reach seats near the rear of the aircraft. The aircraft may therefore enable a reduction in turnaround time.

Aircraft regulations govern that up to 110 passengers may be located in the vicinity of a Type-A exit and up to 55 passengers may be located in the vicinity of a type-C exit. The arrangement of the exits in the aircraft of the first embodiment and the seating in the cabin is such that (contrary to the aircraft described with reference to FIG. 1a) a further emergency exit and associated transverse passageway are not required. The aircraft therefore utilizes cabin length that would otherwise be used to accommodate an emergency exit and passageway, for seating.

The extra seating in the cabin arrangement of the first embodiment of the invention is clear from a comparison of FIGS. 1a and 2. The aircraft of FIG. 1a is arranged to carry 137 seats, whereas the arrangement in FIG. 2 allows 138 seats to be carried.

FIG. 3 shows a passenger cabin on an aircraft according to a second embodiment of the present invention. The cabin is arranged primarily as described with reference to the first embodiment except that the secondary exit 17 is located in the fore of the aircraft, and the pair of primary exits 13 comprises two Type-A exits, each having a width of 1.15 m and a height of 1.80 m. As can be seen from a comparison of FIGS. 1a and 3, the cabin according to the second embodiment is able to carry one passenger more (138 passengers) than the known aircraft arrangement.

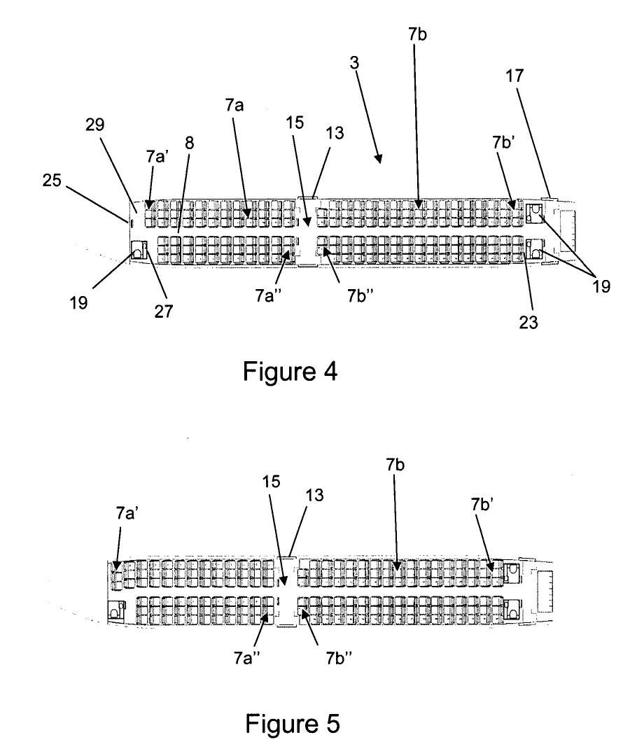

FIG. 4 shows a passenger cabin on an aircraft according to a third embodiment of the present invention (the transverse passageway(s) 15 are not shaded in FIG. 4 or in the subsequent Figures). The aircraft is slightly larger than those described with reference to the first and second embodiments and has a capacity of 169 passengers. The aircraft comprises a pair of primary exits 13 located at 40% cabin length, and a pair of secondary exits 17 located at the rear of the cabin 3 at 95% cabin length. Four sets of seats 7a, 7b are arranged between the central aisle 8 and the transverse passageway 15 adjoining the primary exit 13. A single lavatory 19 is located in the fore of the cabin, and two lavatories 21 are located at the rear of the cabin 3 between the rear sets of seats 7b and the secondary exit 17.

The primary exit is a type-A exit measuring 1.2 m by 2.0 m. The primary exit 13 adjoins a passageway 15 running transverse to the length of the cabin 3. As can be seem from a comparison with the aircraft cabin of FIG. 1b, the cabin according to the third embodiment of the present invention enables an extra four seats to be fitted in the cabin. In the third embodiment of the invention the extra four seats are only shown to illustrate the additional spare made available by the third embodiment of the present invention. The extra capacity could be occupied by the galley (not shown).

Referring to FIG. 4, the two rear sets of seats 7b are bordered at one end by the partitioning wall 23 of the lavatories 21 and at the other end by the transverse passageway 15. The seats are uniformly arranged in rows and columns. All the seats face forward such that the headrests of the rear-most seats 7b′ abut the lavatory partition wall 23, and the front of the foremost seats 7b″ borders the edge of the transverse passageway 15. The leg-room of the foremost seats 7b″ thus protrudes into the passageway 15 but does not significantly affect the useable width of the passageway 15.

The two fore sets of seats 7a are bordered at one end by the transverse passageway 15 and at the other by the cabin bulkhead 25 and the fore lavatory 19 partitioning wall 27. The seats are also uniformly arranged and face forward (in the same manner as the rear sets of seats 7b). Thus, the headrests of the rear-most seats 7a″ border the transverse passageway, and the front of the foremost seats 7a′ are set back slightly from the cabin bulkhead 25 to allow these passengers some leg room 29. The leg-room 29 does not serve any additional function and has been found to be a relatively inefficient use of cabin space.

FIG. 5 shows a cabin arrangement according to a fourth embodiment of the invention. The cabin is primarily as described with reference to the third embodiment except that, importantly, the two front sets of seats 7a face the opposite direction to the rear set of seats 7b (i.e. the cabin is arranged such that both the first and second sets of seats 7a, 7b face towards the passageway 15).

The headrests of the foremost seats 7a′ abut the cabin bulkhead 25 and the fore lavatory 19 partitioning wall 27, whereas the front of the rear-most seats 7a″ border the passageway 15. The leg-room of the rear seats 7a″ of the fore set of seats 7a (and the front seats 7b″ of the rear set of seats 7b) therefore extends into the transverse passageway 15. It is thus possible to fit more seats in the fore of the aircraft as the leg room of the rear-most seats 7a″ is located in the passage. This is clearly demonstrated by the increase of three seats on the aircraft of the fourth embodiment of the invention (FIG. 5) in comparison to the aircraft of the third embodiment of the invention (FIG. 4). The aircraft of the fourth embodiment provides a particular improvement in passenger capacity (eight seats) over the known cabin arrangement described in FIG. 1b.

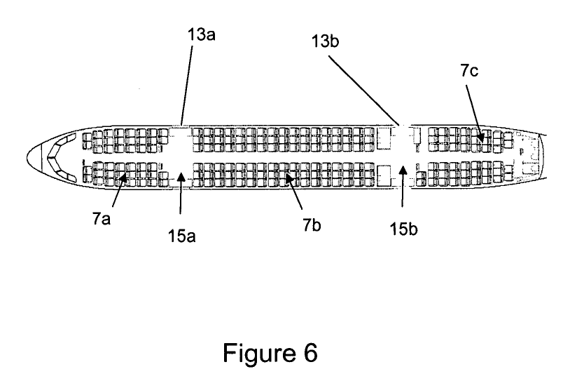

An aircraft according to a fifth embodiment of the invention is shown in FIG. 6. The aircraft is a small passenger aircraft adapted to carry less than 200 passengers. The aircraft has a low-wing (not shown) configuration. The aircraft comprises two pairs of primary exits 13a, 13b, each exit 13a, 13b being a type-A exit of width greater than 1 m. The first pair of primary exits 13a is located at 20% cabin length, and the second pair of exits 13b is located at 75% cabin length. This cabin arrangement provides many of the above-mentioned benefits, but is particularly beneficial on the low-winged aircraft because the exits do not interfere with the wing structure. In addition, having the large exits at 20% and 75% cabin length mitigates the possibility of airbridges connected to those exits, interfering with the aircraft wing structure. The cabin comprises two forward facing sets of seats 7b, 7c at the centre and rear of the cabin respectively, and a single rearward facing set of seats 7a at the front of the cabin. The centre and forward sets of seats 7b, 7a are separated by the passageway 15a extending in a direction transverse to the length of the cabin.

The seating arrangement described above with reference to FIGS. 5 and/or 6 need not necessarily be on an aircraft having the large primary exit in the central region of the aircraft. An aircraft according to a sixth embodiment of the invention (not shown), comprises first and second main exits, and a single third exit for use in emergencies. The exit arrangement is thus similar to the aircraft shown in FIG. 1a. However, in contrast to FIG. 1a, the aircraft according to the sixth embodiment of the invention comprises a set of seats in the fore of the aircraft that face towards the passageway (associated with the third exit), and two sets of seats in the rear of the aircraft that face towards the same passageway. The available cabin length over which the fore set of seats is arranged is thus greater than the aircraft shown in FIG. 1a. According to the sixth embodiment of the invention, the number of seats is not increased, and instead the leg room of each passenger is slightly greater.

Whilst the present invention has been described and illustrated with reference to particular embodiments, it will be appreciated by those of ordinary skill in the art that the invention lends itself to many different variations not specifically illustrated herein. For example, the aircraft may comprise a third set of seats facing in the opposite direction to the second set of seats but positioned directly adjacent to them such that they are arranged back-to-back with the second set of seats. The aircraft may further comprise a fourth set of seats separated from the third set of seats by a transverse passageway, both the third and fourth sets of seats facing towards the passageway. Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. An aircraft comprising a fuselage, a passenger cabin housed therein, and a primary opening for accessing the cabin, wherein the opening is defined by, and is located in a side of, the fuselage, the opening is located in a region extending from 20% to 80% of the total cabin length, and the opening has a width greater than 1 m, so as to be suitable for the side-by-side, simultaneous passage of at least two adult persons walking therethrough.

2. An aircraft according to claim 1, wherein the primary opening is a Type-A exit.

3. An aircraft according to claim 1, wherein the primary opening is located in a region between 40% and 60% of the total length of the cabin.

4. An aircraft according to claim 1, wherein the primary opening is located in a region between either; (a) 20% and 30% of the total length of the cabin, or (b) 70% and 80% of the total length of the cabin.

5. An aircraft according to claim 4, wherein the aircraft is of a size equivalent to an aircraft designed to carry no more than 250 passengers.

6. An aircraft according to claim 1, wherein the cabin comprises a passageway extending in a direction transverse to the length of the cabin, the passageway being arranged to adjoin, and be of substantially equal width as, the primary opening.

7. An aircraft according to claim 1 further comprising a secondary opening for accessing the cabin, and a secondary door associated with the secondary opening, wherein the secondary opening is defined by, and located in a side of, the fuselage, the secondary opening is located at an end region of the cabin, and the secondary opening has a width less than 1 m, so as to be unsuitable for the side-by-side, simultaneous passage of at least two adult persons walking therethrough.

8. An aircraft comprising a passenger cabin, the passenger cabin comprising a first set of seats, and a second set of seats separated from the first set of seats by a passageway extending in a direction transverse to the length of the cabin, each set of seats comprising a plurality of rows of seats, each row comprising a plurality of seats, the first and second sets of seats each facing towards the passageway.

9. An aircraft according to claim 8, wherein the first set of seats is defined by a block of more than 20 uniformly arranged seats and the second set of seats is defined by a block of more than 20 uniformly arranged seats.

10. An aircraft according to claim 8, wherein the passageway adjoins a cabin exit and is located in a central region of the passenger cabin.

11. A method of facilitating boarding of passengers onto an aircraft, the method comprising the steps of:
(a) providing an aircraft comprising a fuselage, a passenger cabin housed therein, and a primary opening for accessing the cabin, and
(b) directing a first adult passenger and a second adult passenger to pass simultaneously, and side-by-side, through the primary opening.

12. A method according to claim 11, further comprising the steps of
(c) directing the first passenger, once through the primary opening, in a first direction along the cabin; and
(d) directing the second passenger, once through the primary opening, in a second direction along the cabin, the second direction being opposite to the first direction.

13. A method according to claim 11, wherein step (a) of the method is performed by providing an aircraft in which the primary opening (i) is defined by, and is located in a side of, the fuselage, (ii) is located in a region extending from 20% to 80% of the total cabin length, and (iii) has a width greater than 1 m.
